(19) United States
(12) Patent Application Publication
(10) Pub. No.: US 2025/0313145 A1
(43) Pub. Date: Oct. 9, 2025

(54) INTEGRATED CAMERA AND LIGHT SYSTEM FOR A VEHICLE

(71) Applicant: Oshkosh Corporation, Oshkosh, WI (US)

(72) Inventor: Eric Linsmeier, Larsen, WI (US)

(73) Assignee: Oshkosh Corporation, Oshkosh, WI (US)

(21) Appl. No.: 19/092,832

(22) Filed: Mar. 27, 2025

Related U.S. Application Data
(60) Provisional application No. 63/574,558, filed on Apr. 4, 2024.

(51) Int. Cl. B60Q 1/00; B60Q 1/30; B60R 11/00; B60R 11/04

(52) U.S. Cl. CPC B60Q 1/0023; B60Q 1/302; B60R 11/04; B60R 2011/004

(57) ABSTRACT

A vehicle includes a chassis, a cab coupled to the chassis, a body coupled to the chassis, an integrated camera and light system, and one or more processing circuits. The integrated camera and light system includes a fixture, a light element disposed within the fixture, and a camera disposed within the fixture and positioned at a predetermined location relative to the light element. The light element is configured to emit a light. The camera is configured to emit a light. The image data includes interference corresponding to the light emitted by the light element. The one or more processing circuits are configured to acquire the image data and process the image data to reduce or filter the interference in the image data based on the camera being positioned at the predetermined location relative to the light element.

### CROSS-REFERENCE TO RELATED PATENT APPLICATION

This application claims the benefit of and priority to U.S. Provisional Patent Application No. 63/574,558, filed Apr. 4, 2024, which is incorporated herein by reference in its entirety.

### BACKGROUND

A vehicle may include a camera positioned on the vehicle and configured to provide image data to a control system of the vehicle. The image data from the camera may be provided to an operator of the vehicle or may be utilized by the control system to operate the vehicle.

### SUMMARY

One embodiment relates to a vehicle including a chassis, a cab coupled to the chassis, a body coupled to the chassis, an integrated camera and light system, and one or more processing circuits. The integrated camera and light system includes a fixture, a light element disposed within the fixture, and a camera disposed within the fixture and positioned at a predetermined location relative to the light element. The light element is configured to emit a light. The camera is configured to emit a light. The image data includes interference corresponding to the light emitted by the light element. The one or more processing circuits are configured to acquire the image data and process the image data to reduce or filter the interference in the image data based on the camera being positioned at the predetermined location relative to the light element.

Another embodiment relates to a vehicle including a chassis, a body assembly coupled to the chassis, an integrated camera and light system, and one or more processing circuits. The integrated camera and light system includes a first light element configured to emit a first light, a second light element configured to emit a second light, and a camera positioned at a first predetermined location relative to the first light element and at a second predetermined location relative to the second light element. The camera is configured to acquire image data. The image data includes first interference corresponding to the first light emitted by the first light element and second interference corresponding to the second light emitted by the second light element. The one or more processing circuits are configured to acquire the image data, process the image data to reduce or filter the first interference in the image data based on the camera being positioned at the first predetermined location relative to the first light element, and process the image data to reduce or filter the second interference in the image data based on the camera being positioned at the second predetermined location relative to the second light element.

Yet another embodiment relates to an integrated camera and light system for a vehicle. The integrated camera and light system includes a fixture, a light element disposed within the fixture, a camera disposed within the fixture and positioned at a predetermined location relative to the light element, a filter positioned between the light element and the camera, a first wire communicably coupled to the light element, a second wire communicably coupled to the camera, and a wiring jacket. The light element is configured to emit a light. The camera is configured to acquire image data. The filter is configured to filter the light emitted by the light element. The first wire extends out of the fixture. The second wire extends out of the fixture. The wiring jacket surrounds at least a portion of the first wire and the second wire extending out of the fixture.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left-side view of a vehicle, according to an exemplary embodiment.

FIG. 2 is a perspective view of the vehicle of FIG. 1 configured as a fire fighting vehicle, according to an exemplary embodiment.

FIG. 3 is a rear view of the fire fighting vehicle of FIG. 2, according to an exemplary embodiment.

FIG. 4 is a front view of the fire fighting vehicle of FIG. 2, according to an exemplary embodiment.

FIG. 5 is a perspective view of the vehicle of FIG. 1 configured as a front loading refuse vehicle, according to an exemplary embodiment.

FIG. 6 is a right side view of the vehicle of FIG. 1 configured as a side loading refuse vehicle, according to an exemplary embodiment.

FIG. 7 is a rear perspective view of the vehicle of FIG. 1 configured as a mixer vehicle, according to an exemplary embodiment.

FIG. 8 is a perspective view of the vehicle of FIG. 1 configured as an airport fire-fighting vehicle, according to an exemplary embodiment.

FIG. 9 is a block diagram of an integrated camera system of the vehicle of FIG. 1, according to an exemplary embodiment.

FIG. 10 is a cross section view of wiring of the integrated camera system of FIG. 9, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle (e.g., a vocational vehicle, a fire apparatus, a refuse vehicle, a concrete mixer truck, a tow truck, a response vehicle, an ambulance, a police vehicle, a construction vehicle, an airport ground support equipment vehicle, etc.) includes an integrated camera and light system that includes cameras and lights that are used to provide image data corresponding to the surroundings of the vehicle and emit light, respectively. The cameras of the integrated camera and light system are positioned at predetermined locations relative to the lights of the integrated camera and light system. In some examples, the integrated camera and light system includes assemblies of fixtures configured to receive the lights and the cameras such that the cameras are positioned in the predetermined locations relative to the lights. The cameras of the integrated camera system may provide image data to a user interface of the vehicle for an operator of the vehicle or may be provided to a control system of the vehicle to be used to operate the vehicle autonomously or semi-autonomously. Camera systems of traditional vehicles can struggle with capturing image data because of light interference caused by lights of the vehicle. For example, a camera on a traditional fire fighting vehicle may provide image data with interference caused by emergency lights of the fire fighting vehicle. Operators using traditional vehicles lose time maneuvering the vehicle or may not utilize autonomous or semi- autonomous operation of the vehicle due to the light interference distorting the image data. The time and money lost by improperly or inefficiently maneuvering the vehicle is avoided by the vehicles according to the disclosure by incorporating image data processing configured to reduce the light interference in the image data provided by the cameras based on the cameras being positioned in predetermined locations relative to the lights. In some embodiments, the integrated camera and lights systems are configured to be modular, which reduces maintenance time of the vehicles and increases the amount of time that the vehicles can operate.

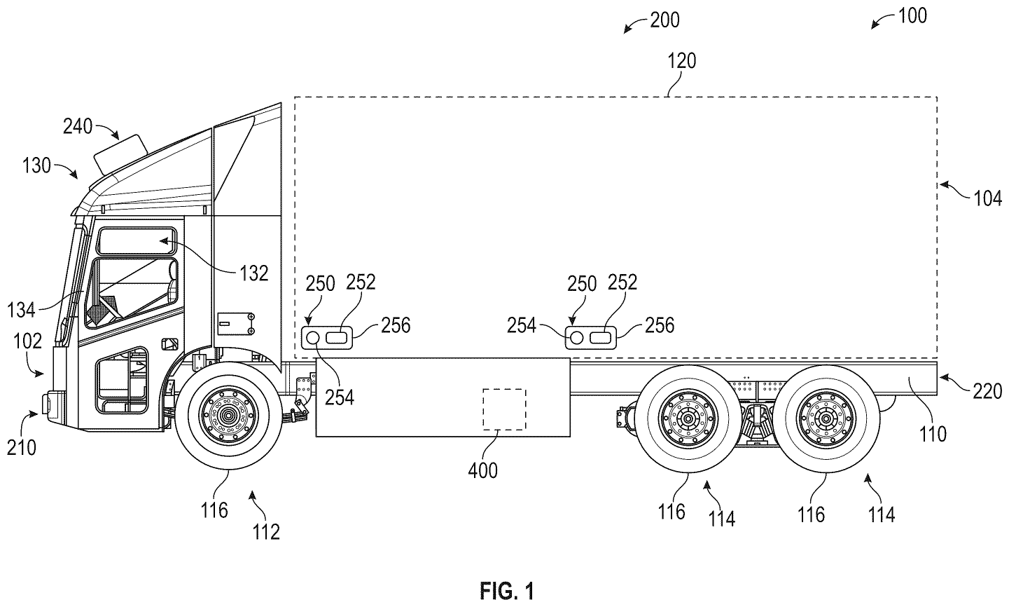

As shown in FIG. 1, a vehicle (e.g., a vehicle assembly, a truck, a vehicle base, etc.), shown as vehicle 100, generally extends longitudinally from a front end 102 (e.g., a forward end, a front, etc.) to a rear end 104 (e.g., a rearward end, a rear, etc.). The primary, forward direction of travel of the vehicle 100 is longitudinal, with the front end 102 being arranged forward of the rear end 104. As shown in FIG. 1, the vehicle 100 includes a frame assembly or chassis assembly, shown as chassis 110, that supports other components of the vehicle 100. The chassis 110 extends longitudinally along a length of the vehicle 100, substantially parallel to a primary direction of travel of the vehicle 100.

As shown in FIG. 1. the vehicle 100 includes a series of axle assemblies, shown as front axle 112 and rear axle(s) 114. According to the exemplary embodiment shown in FIG. 1, the vehicle 100 includes one front axle 112 coupled to the chassis 110 proximate the front end 102 of the vehicle 100 (e.g., at a forward end of the chassis 110) and two rear axles 114 each coupled to the chassis 110 proximate the rear end 104 of the vehicle 100 (e.g., at a rearward end of the chassis 110, etc.). In other embodiments, the vehicle 100 includes more or fewer axles. By way of example, the vehicle 100 may include a tag axle that may be raised or lowered to accommodate variations in weight being carried by the vehicle 100. By way of another example, the vehicle 100 may only include one rear axle 114. As shown in FIG. 1, the front axle 112 and the rear axles 114 include tractive elements (e.g., wheels, treads, etc.), shown as wheel and tire assemblies 116. The wheel and tire assemblies 116 are configured to engage a support surface (e.g., roads, the ground, etc.) to support and propel the vehicle 100. The front axle 112 and the rear axles 114 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle 100.

In some embodiments, the vehicle 100 is configured as an electric vehicle that is propelled by an electric powertrain system. By way of example, the vehicle 100 may include one or more electrical energy storage devices (e.g., batteries, capacitors, etc.) that are positioned within the chassis 110. In other embodiments, the electrical energy storage devices are otherwise positioned throughout the vehicle 100. The electrical energy storage devices may include one or more rechargeable batteries (e.g., lithium-ion batteries, nickel-metal hydride batteries, lithium-ion polymer batteries, lead-acid batteries, nickel-cadmium batteries, etc.). The rechargeable batteries may be charged by one or more sources of electrical energy onboard the vehicle 100 (e.g., solar panels, etc.) or separate from the vehicle 100 (e.g., connections to an electrical power grid, a wireless charging system, etc.). The vehicle 100 may further include one or more electromagnetic devices or prime movers (e.g., motors/generators). The electromagnetic devices or prime movers may be configured to receive electric energy from the electrical energy storage devices and provide rotational mechanical energy to the wheel and tire assemblies 116 to propel the vehicle 100. By way of example, the electromagnetic devices or prime movers may be positioned within the rear axles 114. In other embodiments, the electromagnetic devices or prime movers are otherwise positioned within the vehicle 100. The electromagnetic devices or prime movers may also be configured to receive rotational mechanical energy from the wheel and tire assemblies 116 and provide electrical energy to the electrical energy storage devices, providing a braking force to slow the vehicle 100.

In some embodiments, the vehicle 100 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, propane, natural gas, etc.) to provide mechanical energy, which a transmission may receive and provide to the front axle 112 and/or the rear axles 114 to propel the vehicle 100. Additionally, or alternatively, the primary driver may provide mechanical energy to the generator, which converts the mechanical energy into electrical energy. The electrical energy may be stored in the energy storage device in order to later be provided to a motive driver.

In some embodiments, the vehicle 100 is configured as a traditional vehicle that is propelled by a non-hybrid powertrain system. For example, the powertrain system may include a primary driver that is a spark-ignition or compression-ignition internal combustion engine that utilizes fuel (e.g., gasoline, diesel, propane, natural gas, etc.).

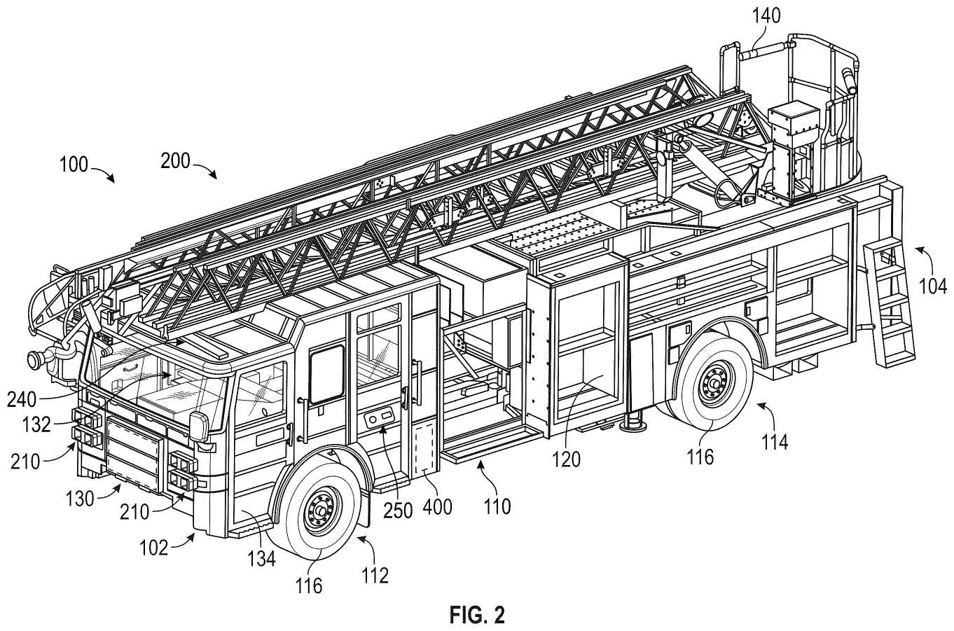

As shown in FIG. 1, the vehicle 100 includes a rear assembly, module, implement, or cargo area, shown as body 120. The body 120 may include one or more vehicle bodies, and/or other components. The vehicle 100 may be outfitted with a variety of different versions of the body 120 to configure the vehicle 100 for use in different applications. Accordingly, a common base of the vehicle 100 can be configured for a variety of different uses by selecting an appropriate version of the body 120. By way of example, the vehicle 100 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a response vehicle, an ambulance, a police vehicle, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), an airport ground service equipment vehicle (e.g., a cargo loader, a tractor, a de-icer, etc.), and/or still another vehicle. FIGS. 2-8 illustrate various examples of how the vehicle 100 may be configured for specific applications. Although only a certain set of vehicle configurations is shown, it should be understood that the vehicle 100 may be configured for use in other applications that are not shown.

As shown in FIG. 1, the vehicle 100 includes a cabin, operator compartment, or body component, shown as cab 130, is coupled to the chassis 110 proximate the front end 102 of the vehicle 100 (e.g., at a forward end of the chassis 110, etc.). The cab 130 extends above the chassis 110. The cab 130 includes an enclosure or main body that defines an interior volume, shown as cab interior 132, that is sized to contain one or more operators. The cab 130 also includes one or more doors 134 that facilitate selective access to the cab interior 132 from outside of the vehicle 100. The cab interior 132 contains one or more components that facilitate operation of the vehicle 100 by the operator. By way of example, the cab interior 132 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 130 may facilitate operator control over the drive components of the vehicle 100 and/or over any implements of the vehicle 100. Although the cab 130 is shown positioned forward the body 120, in other embodiments the body 120 extends of forward the cab 130.

As shown in FIGS. 2-8, the vehicle 100 includes an application kit or implement, shown as auxiliary assembly 140. The auxiliary assembly 140 may be coupled to the chassis 110, to the body 120, and/or to the cab 130. The vehicle 100 may be outfitted with a variety of different versions of the auxiliary assembly 140 to configure the vehicle 100 for use in different applications. Accordingly, a common base of the vehicle 100 can also be configured for a variety of different uses by selecting an appropriate version of the auxiliary assembly 140. The auxiliary assembly 140 may include various implements that allow for certain functions of the vehicle 100. By way of example, the auxiliary assembly 140 may include arms, grabbers, man baskets, ladders, lifts, and/or other implements. The auxiliary assembly 140 may also include various actuators to facilitate certain functions of the vehicle 100. By way of example, the auxiliary assembly 140 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The auxiliary assembly 140 may include components that facilitate operation of and/or control of these actuators. By way of example, the auxiliary assembly 140 may include hydraulic or pneumatic components that form a hydraulic or pneumatic circuit (e.g., conduits, valves, pumps, compressors, gauges, reservoirs, accumulators, etc.). By way of another example, the auxiliary assembly 140 may include electrical components (e.g., batteries, capacitors, voltage regulators, motor controllers, etc.). The actuators may be powered by components of the vehicle 100. By way of example, the actuators may be powered by batteries, drive motors, or a primary driver (e.g., through a power take off).

### A. Fire Truck

Referring to FIGS. 2-4, the vehicle 100 is configured as a fire fighting vehicle, fire truck, or fire apparatus (e.g., a turntable ladder truck, a pumper truck, a quint, etc.). In the embodiment shown in FIGS. 2-4, the vehicle 100 is configured as a rear-mount aerial ladder truck. In other embodiments, the vehicle 100 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. By way of example, the vehicle 100 may be configured as a police vehicle, an ambulance, a tow truck, or still other vehicles used for responding to a scene (e.g., an accident, a fire, an incident, etc.).

According to the exemplary embodiment shown in FIG. 2 of the vehicle 100 configured as the fire fighting vehicle, the body 120 is positioned rearward from the cab 130. The body 120 includes deployable stabilizers (e.g., outriggers, downriggers, etc.) configured to selectively extend from each lateral side and/or the rear of the vehicle 100 and engage a support surface (e.g., the ground) to provide increased stability while the vehicle 100 is stationary. The increased stability provided by the outriggers may be desirable when the auxiliary assembly 140 is in use to prevent tipping of the vehicle 100. The body 120 also includes various storage compartments (e.g., cabinets, lockers, etc.) that may be selectively opened and/or accessed for storage and/or component inspection, maintenance, and/or replacement.

According to the exemplary embodiment shown in FIG. 2, the auxiliary assembly 140 includes an extendable or telescoping ladder assembly. The ladder assembly may include a series of ladder sections that are slidably coupled with one another such that the ladder sections may extend and/or retract (e.g., telescope, etc.) relative to one another to selectively vary a length of the ladder assembly of the auxiliary assembly 140. In some embodiments, the auxiliary assembly 140 includes a turntable rotatably coupled to the body 120 or the chassis 110 and a proximal end of the ladder assembly. The turntable may be configured to rotate relative to the chassis 110 to rotate the ladder assembly relative to the chassis 110. In some embodiments, the auxiliary assembly 140 also includes an implement coupled to a distal end of the ladder assembly. For example, the implement may be a water turret configured to expel water and/or a fire suppression agent (e.g., foam, etc.) from a water storage and/or an agent tank onboard the vehicle 100 and/or from an external source (e.g., a fire hydrant, a separate water/pumper truck, etc.). In some embodiments, the auxiliary assembly 140 further includes an aerial platform coupled to the distal end of the ladder assembly and configured to support one or more operators.

### B. Front-Loading Refuse Vehicle

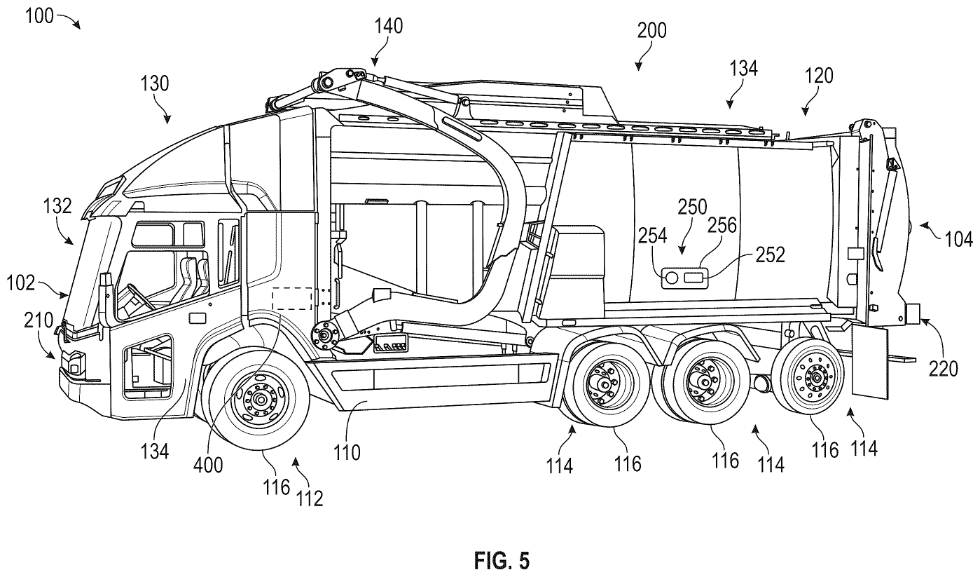

Referring now to FIG. 5, the vehicle 100 is configured as a refuse vehicle (e.g., a refuse truck, a garbage truck, a waste collection truck, a sanitation truck, a recycling truck, etc.). Specifically, the vehicle 100 is configured as a front-loading refuse vehicle. In other embodiments, the vehicle 100 may be configured as a rear-loading refuse vehicle. The vehicle 100 may be configured to transport refuse from various waste receptacles (e.g., refuse containers) within a municipality to a storage and/or processing facility (e.g., a landfill, an incineration facility, a recycling facility, etc.).

According to the exemplary embodiment shown in FIG. 5, the vehicle 100 includes three of the rear axles 114. The rearmost of the rear axles 114 (e.g., the rear axle 114 proximate the rear end 104, etc.) is configured as a liftable axle. The lift able axle can be selectively raised and lowered (e.g., by a hydraulic actuator, etc.) to selectively engage the wheel and tire assemblies 116 of the liftable axle with the ground. The liftable axle may be raised to reduce rolling resistance experienced by the vehicle 100. The liftable axle may be lowered to distribute the weight of the vehicle 100 across a greater number of the wheel and tire assemblies 116 (e.g., when the refuse vehicle is loaded with refuse, etc.).

As shown in FIGS. 5, the body 120 of the vehicle 100 includes a series of panels that form a rear body or container, shown as a refuse compartment. The refuse compartment may facilitate transporting refuse from various waste receptacles within a municipality to a storage and/or a processing facility (e.g., a landfill, an incineration facility, a recycling facility, etc.). By way of example, loose refuse may be placed into the refuse compartment where it may be compacted (e.g., by a packer system within the refuse compartment). The refuse compartment may also provide temporary storage for refuse during transport to a waste disposal site and/or a recycling facility. In some embodiments, the refuse compartment may define a hopper volume and storage volume. In this regard, refuse may be initially loaded into the hopper volume and later compacted into the storage volume. The hopper volume may be positioned between the storage volume and the cab 130 (e.g., refuse is loaded into a portion of the refuse compartment behind the cab 130 and stored in a portion further toward the rear of the vehicle 100). In other embodiments, the storage volume may be positioned between the hopper volume and the cab 130 (e.g., in a rear-loading refuse truck, etc.). The body 120 of the vehicle 100 further includes a tailgate that is pivotally coupled to the refuse compartment. The tailgate may be selectively repositionable between a closed position and an open position by an actuator (e.g., a hydraulic cylinder, an electric linear actuator, etc.) to facilitate emptying the storage volume.

As shown in FIG. 5, the auxiliary assembly 140 of the vehicle 100 is configured as a front-loading lift assembly. According to an exemplary embodiment, the auxiliary assembly 140 includes a pair of lift arms and a pair of lift arm actuators (e.g., hydraulic cylinders, electric linear actuators, etc.). The lift arms may be rotatably coupled to the chassis 110 and/or the body 120 on each side of the vehicle 100 (e.g., through a pivot, a lug, a shaft, etc.), such that the auxiliary assembly 140 may extend forward relative to the cab 130 (e.g., a front-loading refuse truck, etc.). In other embodiments, the auxiliary assembly 140 may extend rearward relative to the body 120 (e.g., a rear-loading refuse truck). As shown in FIG. 5, in an exemplary embodiment the lift arm actuators may be positioned such that extension and retraction of the lift arm actuators rotates the lift arms about an axis extending through the pivot. In this regard, the lift arms may be rotated by the lift arm actuators to lift a refuse container over the cab 130. The auxiliary assembly 140 further includes a pair of interface members, each pivotally coupled to a distal end of one of the lift arms. The interface members may be configured to engage a refuse container (e.g., a dumpster) to selectively couple the refuse container to the lift arms. By way of example, each of the lift forks may be received within a corresponding pocket defined by the refuse container. A pair of articulation actuators (e.g., hydraulic cylinders, electric linear actuators, etc.) are each coupled to one of the lift arms and one of the lift forks. The articulation actuators may be positioned to rotate the lift forks relative to the lift arms about a horizontal axis. Accordingly, the articulation actuators may assist in tipping refuse out of the refuse container and into the refuse compartment of the body 120. The lift arm actuators may then rotate the lift arms to return the empty refuse container to the ground.

### C. Side-Loading Refuse Vehicle

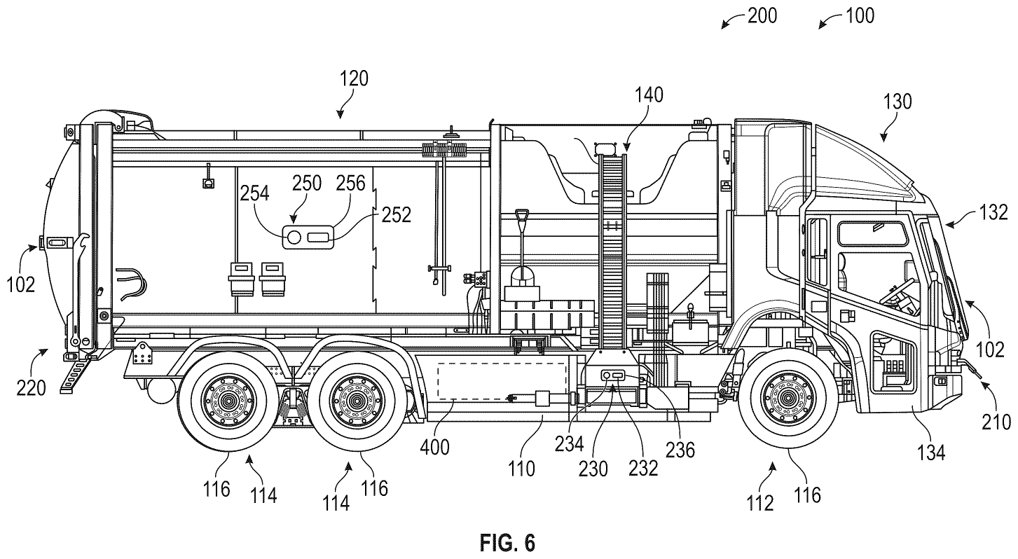

Referring now to FIG. 6, the vehicle 100 is configured as a refuse vehicle. Specifically, the vehicle 100 is configured as a side-loading refuse vehicle. According to the exemplary embodiment shown in FIG. 6, the body 120 of the vehicle 100 includes a series of panels that form a rear body or container and the auxiliary assembly 140 is configured as a side-loading lift assembly that extends laterally outward from a side of the vehicle 100. According to an exemplary embodiment, the auxiliary assembly 140 includes a grabber assembly that is configured to engage a refuse container (e.g., a residential garbage can, etc.). The grabber assembly includes a main portion and a pair of grabber fingers pivotably coupled to the main portion. A pair of finger actuators are configured to control movement of the grabber fingers relative to the main portion.

According to the exemplary embodiment shown in FIG. 6, the auxiliary assembly 140 also includes a track that extends vertically along a side of the vehicle 100. The grabber assembly of the auxiliary assembly 140 is movably coupled to the track. Specifically, the grabber assembly is slidably coupled to the track such that the grabber assembly is repositionable along a length of the track. A lift actuator is configured to control movement of the grabber assembly along the length of the track. In some embodiments, a bottom end portion of the track is straight and substantially vertical such that the grabber assembly raises or lowers a refuse container when moving along the bottom end portion of the track. In some embodiments, a top end portion of the track is curved such that the grabber assembly inverts a refuse container to dump refuse into the body 120 when moving along the top end portion of the track.

According to the exemplary embodiment shown in FIG. 6, the auxiliary assembly 140 further includes a track actuator that is configured to control lateral movement of the grabber assembly. By way of example, the track actuator may be coupled to the chassis 110 and the track such that the track actuator moves the track and the grabber assembly laterally relative to the chassis 110. The track actuator may facilitate repositioning the grabber assembly to pick up and replace refuse containers that are spaced laterally outward from the vehicle 100.

### D. Concrete Mixer Truck

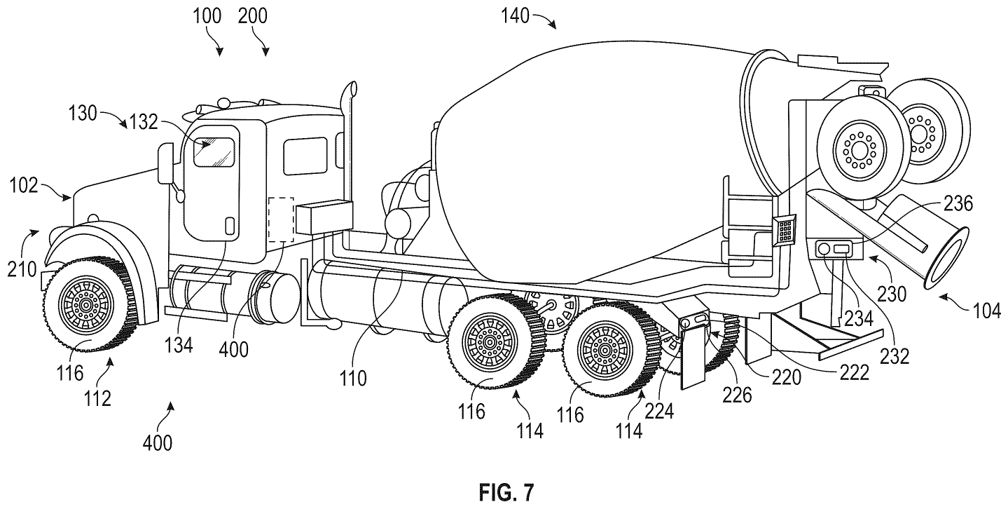

Referring now to FIG. 7, the vehicle 100 is configured as a mixer truck (e.g., a concrete mixer truck, a mixer vehicle, etc.). Specifically, the vehicle 100 is shown as a rear-discharge concreate mixer truck. In other embodiments, the vehicle 100 may be configured as a front-discharge concrete mixer truck.

According to the exemplary embodiment shown in FIG. 7, the body 120 of the vehicle 100 includes a mixing drum assembly (e.g., a concrete mixing drum). The mixing drum assembly may include a mixing drum, a drum drive system (e.g., a rotational actuator or motor, such as an electric motor or hydraulic motor), an inlet portion, and an outlet portion. The mixing drum may be coupled to the chassis 110 and may be disposed behind the cab 130 (e.g., at the rear and/or middle of the chassis 110). In an exemplary embodiment, the drum drive system is coupled to the chassis 110 and configured to selectively rotate the mixing drum about a central, longitudinal axis. According to an exemplary embodiment, the central, longitudinal axis of the mixing drum may be elevated from the chassis 110 (e.g., from a horizontal plane extending along the chassis 110) at an angle in the range of five degrees to twenty degrees. In other embodiments, the central, longitudinal axis may be elevated by less than five degrees (e.g., four degrees, etc.). In yet another embodiment, the vehicle 100 may include an actuator positioned to facilitate adjusting the central, longitudinal axis to a desired or target angle (e.g., manually in response to an operator input/command, automatically according to a control system, etc.).

The mixing drum may be configured to receive a mixture, such as a concrete mixture (e.g., cementitious material, aggregate, sand, etc.), through the inlet portion. In some embodiments, the vehicle 100 includes an injection system (e.g., a series of nozzles, hoses, and/or valves) including an injection valve that selectively fluidly couples a supply of fluid to the inner volume of the mixing drum. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum. The injection valve may facilitate injecting water and/or chemicals from a fluid reservoir (e.g., a water tank, etc.) into the mixing drum, while preventing the mixture in the mixing drum from exiting the mixing drum through the injection system. In some embodiments, one or more mixing elements (e.g., fins, etc.) may be positioned in the interior of the mixing drum, and may be configured to agitate the contents of the mixture when the mixing drum is rotated in a first direction (e.g., counterclockwise, clockwise, etc.), and drive the mixture out through the outlet portion when the mixing drum is rotated in a second direction (e.g., clockwise, counterclockwise, etc.). In some embodiments, the outlet portion may also include an actuator positioned such that the outlet portion may be selectively pivotable to position the outlet portion (e.g., vertically, laterally, etc.), for example at an angle at which the mixture is expelled from the mixing drum.

### E. ARFF Truck

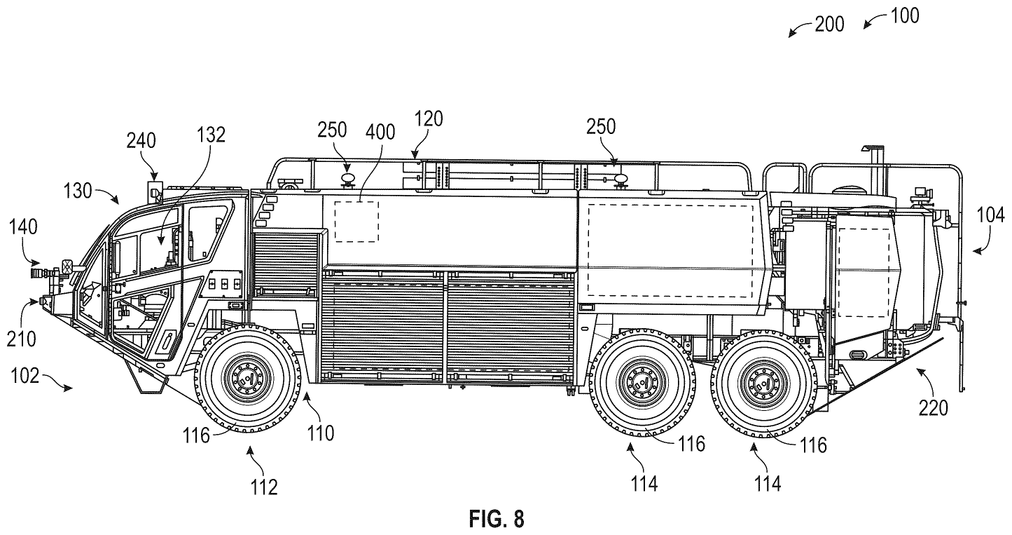

Referring now to FIG. 8, the vehicle 100 is configured as an airport rescue and firefighting truck. As shown in FIG. 8, the body 120 is positioned primarily rearward of the cab 130. As shown, the body 120 includes a series of storage compartments or cabinets that are coupled to the chassis 110. The compartments may store various equipment or components of the vehicle 100.

According to the exemplary embodiment shown in FIG. 8, the body 120 includes a pump system (e.g., an ultra-high-pressure pump system, etc.) positioned within one of the compartments near the center of the vehicle 100. The body 120 further includes a water tank and an agent tank. The pump system may include a high-pressure pump and/or a low-pressure pump, which may be fluidly coupled to the water tank and/or the agent tank. The pump system may to pump water and/or fire suppressing agent from the water tank and the agent tank.

According to the exemplary embodiment shown in FIG. 8, the auxiliary assembly 140 incudes a water turret. The water turret may receive water and/or fire suppressing agent from the pump system of the body 120. The water turret may be selectively reoriented by an operator to adjust a direction of a stream of water and/or agent. As shown in FIG. 8, the water turret is coupled to a front end of the cab 130.

### Integrated Camera and Light System

As shown in FIGS. 1-8, the vehicle 100 includes a camera and light system, shown as integrated camera and light system 200. According to an exemplary embodiment, the integrated camera and light system 200 includes one or more light elements or components configured to emit light. One or more light components of the integrated camera and light system 200 may emit a constant, bright light forward of the vehicle 100 to illuminate a path of the vehicle 100 (e.g., headlights, spotlights, etc.) and/or one or more of the light components may emit a intermittent or flashing lights (e.g., a warning light, a turn signal, a hazard light, emergency lights, etc.). According to an exemplary embodiment, the integrated camera and light system 200 includes one or more cameras configured to acquire image data corresponding to the surroundings of the vehicle 100. For example, the integrated camera and light system 200 may include cameras configured to acquire image data corresponding to the surroundings in front of the vehicle 100, image data corresponding to the surroundings behind the vehicle 100, image data corresponding to the surroundings on the sides of the vehicle 100, etc.

As shown in FIGS. 1-9, the integrated camera and light system 200 includes at least one first light assembly, shown as headlight assembly 210. According to an exemplary embodiment, the headlight assembly 210 is configured to provide illumination to the surroundings of the vehicle 100 positioned forward of the vehicle 100 and/or to acquire image data corresponding to the surroundings of the vehicle 100 positioned forward of the vehicle 100. In some embodiments, the headlight assembly 210 is coupled to the chassis 110 or the cab 130 proximate the front end 102 of the vehicle 100. For example, the vehicle 100 may include a pair of the headlight assemblies 210 coupled to a front of the cab 130 and positioned such that the headlight assemblies 210 are orientated forward relative to the vehicle 100.

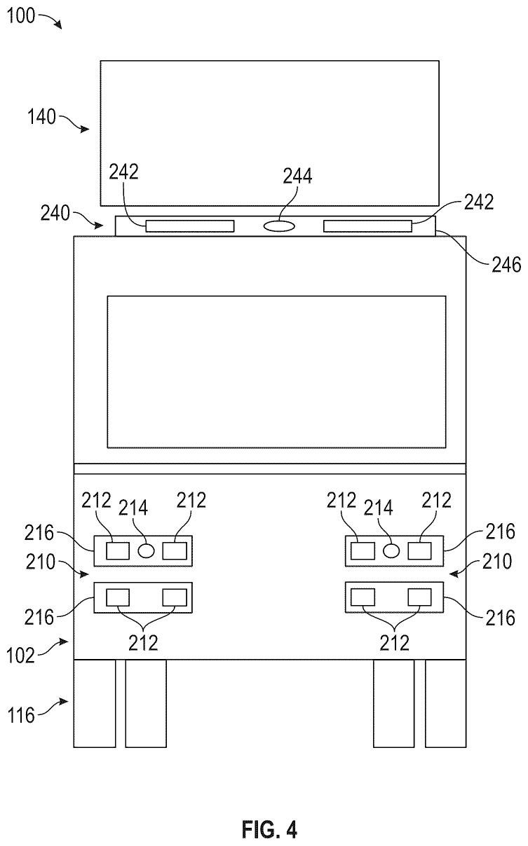

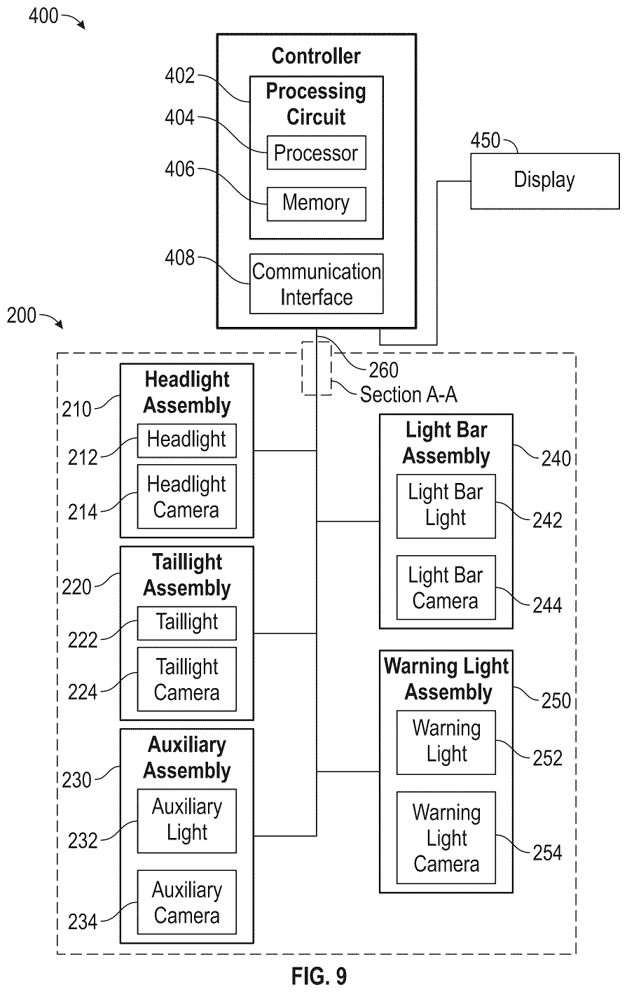

As shown in FIGS. 4 and 9, each of the headlight assemblies 210 includes a first light element (e.g., first light emitter, etc.), shown as headlight 212. The headlight 212 is configured to provide illumination forward of the vehicle 100. In some embodiments, the headlight 212 may be configured with multiple illumination settings. For example, the headlight 212 may include a normal operating mode with a first brightness and a bright operating mode with a second brightness that is brighter than the first brightness. In some embodiments, the headlight assembly 210 includes a plurality of the headlights 212. In various embodiments, each of the headlights 212 of the headlight assembly 210 is configured to operate independently. For example, a first of the headlights may be configured to illuminate the surroundings of the vehicle 100 forward of the vehicle 100 and a second of the headlights 212 may be configured to signal an intent to turn the vehicle 100 based on an input from an operator of the vehicle 100 (e.g., a turn indicator, a turn signal, etc.).

As shown in FIGS. 4 and 9, each of the headlight assemblies 210 includes a first sensor (e.g., a first camera, etc.), shown as headlight camera 214. The headlight camera 214 is configured to acquire image data corresponding to the surroundings of the vehicle 100 positioned forward of the vehicle 100. For example, the headlight camera 214 may capture image data corresponding to objects positioned in front of the vehicle 100. In some embodiments, the headlight camera 214 is positioned in a predetermined location relative to the headlight 212. For example, the headlight camera 214 may be positioned a first predetermined distance away from the headlight 212. As another example, for a headlight assembly 210 that includes multiple of the headlights 212, the headlight camera 214 may be positioned a first predetermined distance away from a first of the headlights 212 and a second predetermined distance away from a second of the headlights 212. In some embodiments, the first predetermined distance is equal to the second predetermined distance. In other embodiments, the first predetermined distance is not equal to the second predetermined distance. In some embodiments, the predetermined location of the headlight camera 214 relative to the headlights 212 depends on a function of the headlight 212. For example, the headlight camera 214 may be positioned in a first predetermined location relative to a first one of the headlights 212 configured to illuminate the surroundings of the vehicle 100 forward of the vehicle 100 and may be positioned in a second predetermined location relative to a second one of the headlights 212 configured to signal an intended turn of the vehicle 100. In some embodiments, the headlight assembly 210 may include multiple of the headlight cameras 214 positioned in predetermined positions of the headlight assembly 210.

As shown in FIG. 4, the headlight assembly 210 includes a first fixture (e.g., a first housing, a first mount, etc.), shown as headlight fixture 216. The headlight fixture 216 is configured to receive the headlight(s) 212 and the headlight camera(s) 214 such that the headlight camera(s) 214 is (are) positioned in the predetermined location(s) relative to the headlight(s) 212. For example, the headlight fixture 216 may include one or more first apertures configured to receive the one or more headlights 212 and one or more second apertures positioned in the predetermined location(s) relative to the one or more first apertures and configured to receive the one or more headlight cameras 214 such that the one or more headlights 212 and the one or more headlight cameras 214 are disposed within the headlight fixture 216 when they are received by the headlight fixture 216. In various embodiments, the headlight fixture 216 is configured to receive a plurality of the headlights 212 and/or a plurality of the headlight cameras 214 such that the headlight cameras 214 are positioned in predetermined locations relative to each of the headlights 212. In some embodiments, the headlight assembly 210 includes multiple of the headlight fixtures 216. For example, the headlight assembly 210 may include a first one of the headlight fixtures 216 configured to receive a first one of the headlights 212 and the headlight camera 214 such that the headlight camera 214 is positioned in a first predetermined location relative to the first of the headlights 212 and the headlight assembly 210 may also include a second one of the headlight fixtures 216 configured to receive a second one of the headlights 212 and configured to couple to the vehicle 100 at a location that results in the headlight camera 214 being positioned in a second predetermined location relative to the second one of the headlights 212.

In some embodiments, the headlight assembly 210 is configured to be modular. For example, if a first one of the headlight assemblies 210 coupled to the vehicle 100 malfunctions (e.g., breaks, no longer works, etc.), an operator of the vehicle 100 may remove the first of the headlight assemblies 210 and install a second one of the headlight assemblies 210 that is functional. As a result, whenever an issue arises with the headlight assembly 210, an entirety of the headlight assembly 210 may be replaceable, including the headlight(s) 212 and the camera(s) 214. This replacement capability may reduce the time that the vehicle 100 is out of service for maintenance or repair activities. In some embodiments, the components of the headlight assembly 210 may be replaced. For example, if a first one of the headlight cameras 214 malfunctions, an operator of the vehicle may replace the first one of the headlight cameras 214 with a second one of the headlight cameras 214 without replacing the remaining components of the headlight assembly 210.

As shown in FIG. 4, the integrated camera and light system 200 of the vehicle 100 includes a pair of the headlight assemblies 210 coupled to the cab 130 of the vehicle 100 on the front end 102 of the vehicle 100. A first one of the headlight assemblies 210 is positioned on a left side of the cab 130 and a second one of the headlight assemblies 210 is positioned on a right side of the cab 130. Each of the headlight assemblies 210 includes a pair of headlight fixtures 216. A first one of the headlight cameras 214 and a first pair of the headlights 212 are disposed within a first one of the headlight fixtures 216. The first pair of headlights 212 are positioned on either side of the headlight camera 214. The first one of the headlight cameras 214 is positioned in a first predetermined location relative to each of the first pair of the headlights 212. A second pair of the headlights 212 are disposed within a second one of the headlight fixtures 216. The second of the headlight fixtures 216 is also coupled to the front end 102 of the cab of 130 of the vehicle 100 at a location that results in a second one of the headlight cameras 214 being positioned in a second predetermined location relative to the second pair of the headlights 212. In some embodiments, the headlight cameras 214 are positioned in other predetermined locations of the headlight fixtures 216 and the headlights 212.

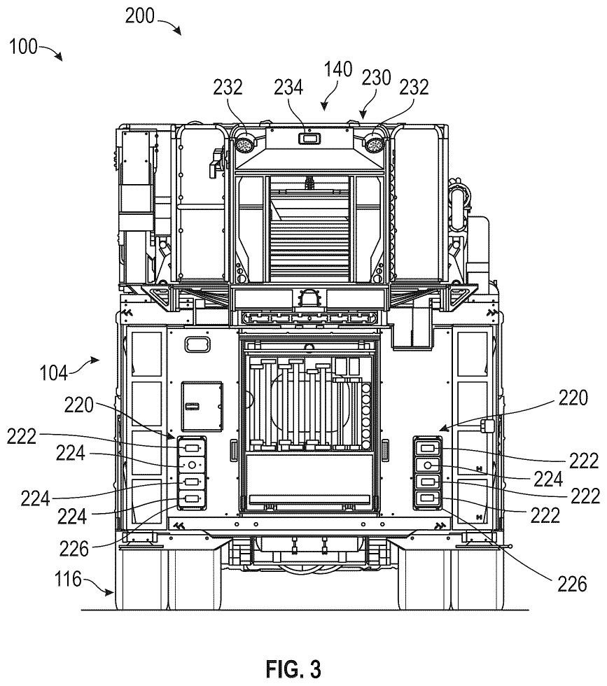

As shown in FIGS. 1, 3, and 5-9, the integrated camera and light system 200 includes at least one second light assembly, shown as taillight assembly 220. The taillight assembly 220 is configured to provide illumination to the surroundings of the vehicle 100 positioned rearward of the vehicle 100 and to provide image data corresponding to the surroundings of the vehicle 100 positioned rearward of the vehicle 100. In some embodiments, the taillight assembly 220 is coupled to the chassis 110 or the body 120 proximate the rear end 104 of the vehicle 100. For example, the vehicle 100 may include a pair of the taillight assemblies 220 coupled to a rear of the body 120 and positioned such that the taillight assemblies 220 are orientated rearward relative to the vehicle 100. As shown in FIGS. 3, 7, and 9, the taillight assembly 220 includes a second light element (e.g., a second light emitter, etc.), shown as taillight 222. The taillight 222 is configured to provide illumination rearward of the vehicle 100. In some embodiments, the taillight 222 may be configured with multiple illumination settings. For example, the taillight 222 may include a normal operating mode with a first brightness and a bright operating mode with a second brightness that is brighter than the first brightness. In some embodiments, the taillight assembly 220 may include a plurality of the taillights 222. In various embodiments, each of the taillights 222 of the taillight assembly 220 may be configured to operate independently. For example, a first one of the taillights 222 may be configured to illuminate the surroundings of the vehicle 100 rearward of the vehicle 100 (e.g., running lights, backup lights, etc.), a second one of the taillights 222 may be configured to signal an intent to turn the vehicle 100 based on an input from an operator of the vehicle 100 (e.g., a turn indicator, a turn signal, etc.), and a third one of the taillights 222 may be configured to signal that the vehicle 100 is braking (e.g., brake lights, etc.).

As shown in FIGS. 3, 7, and 9, the taillight assembly 220 includes a second camera, shown as taillight camera 224 (e.g., a reverse camera, a back-up camera, etc.). The taillight camera 224 is configured to provide image data corresponding to the surroundings of the vehicle 100 positioned rearward of the vehicle 100. For example, the taillight camera 224 may capture image data corresponding to objects positioned behind the vehicle 100. In some embodiments, the taillight camera 224 is positioned in a predetermined location relative to the taillight 222. For example, the taillight camera 224 may be positioned a first predetermined distance away from the taillight 222. As another example, for a taillight assembly 220 that includes multiple of the taillights 222, the taillight camera 224 may be positioned a first predetermined distance away from a first of the taillights 222 and a second predetermined distance away from a second of the taillights 222. In some embodiments, the first predetermined distance is equal to the second predetermined distance. In other embodiments, the first predetermined distance is not equal to the second predetermined distance. In some embodiments, the predetermined location of the taillight camera 224 relative to the taillights 222 depends on a function of the taillight 222. For example, the taillight camera 224 may be positioned in a first predetermined location relative to a first of the taillights 222 configured to signal that the vehicle 100 is braking and may be positioned in a second predetermined location relative to a second of the taillights 222 configured to signal an intended turn of the vehicle 100. In some embodiments, the taillight assembly 220 may include multiple of the taillight cameras 224 positioned in predetermined positions of the taillight assembly 220.

As shown in FIGS. 3 and 7, the taillight assembly 220 includes a second fixture (e.g., a second housing, a second mount, etc.), shown as taillight fixture 226. The taillight fixture 226 is configured to receive the taillight 222 and the taillight camera 224 such that the taillight camera 224 is positioned in the predetermined location relative to the taillight 222. For example, the taillight fixture 226 may include a first aperture configured to receive the taillight 222 and a second aperture positioned in the predetermined location relative to the first aperture configured to receive the taillight camera 224 such that the taillight 222 and the taillight camera 224 are disposed within the taillight fixture 226 when they are received by the taillight fixture 226. In various embodiments, the taillight fixture 226 is configured to receive a plurality of the taillights 222 and/or a plurality of the taillight cameras 224 such that the taillight cameras 224 are positioned in predetermined locations relative to each of the taillights 222.

As shown in FIG. 3, the integrated camera and light system 200 the vehicle 100 includes a pair of the taillight assemblies 220 coupled to the body 120 of the vehicle 100 on the rear end 104 of the vehicle 100. A first one of the taillight assemblies 220 is positioned on a left side of the body 120 and a second one of the taillight assemblies 220 is positioned on a right side of the body 120. Each of the taillight assemblies 220 includes one of the taillight fixtures 226 coupled to the rear end 104 of the body 120 of the vehicle 100 configured to receive the taillight camera 224 and three of the taillights 222. The taillight camera 224 and the three of the taillights 222 are disposed within the one of the taillight fixtures 226. A first one of the taillights 222 is positioned above the taillight camera 224 that results in the taillight camera 224 being positioned in a first predetermined location relative to the first of the taillights 222. A second one of the taillights 222 is positioned below the taillight camera 224 that results in the taillight camera 224 being positioned in a second predetermined location relative to the second of the taillights 222. A third one of the taillights 222 is positioned below the second of the taillights 222 that results in the taillight camera 224 being positioned in a third predetermined location relative to the third of the taillights 222.

As shown in FIGS. 3, 7, and 9, the integrated camera and light system 200 includes at least one third light assembly, shown as auxiliary light assembly 230. The auxiliary light assembly 230 is configured to emit a light to the surroundings of the vehicle 100 positioned proximate the auxiliary assembly 140 and/or emit a light on the auxiliary assembly 140. In some embodiments, the auxiliary light assembly 230 is configured to provide image data corresponding to operation of the auxiliary assembly 140. In some embodiments, the auxiliary light assembly 230 is coupled to the auxiliary assembly 140, or is coupled to the body 120 or the cab 130 proximate the auxiliary assembly 140. For example, the auxiliary assembly 140 may include a lift arm and the auxiliary light assembly 230 may be coupled to or proximate the lift arm and be configured to illuminate the lift arm and/or the area surrounding the lift arm and provide image data corresponding to operation of the lift arm (e.g., image data corresponding to alignment of the lift arm, image data corresponding to movement of the lift arm, etc.). As shown in FIGS. 3, 7, and 9, the auxiliary light assembly 230 includes a third light element, shown as auxiliary light 232. The auxiliary light 232 is configured to provide illumination to the auxiliary assembly 140 and/or the surroundings of the vehicle 100 positioned proximate the auxiliary assembly 140. In some embodiments, the auxiliary light 232 may be configured with multiple illumination settings. For example, the auxiliary light 232 may be configured to provide illumination with a first color when the auxiliary assembly 140 is not being operated and may be configured to provide illumination with a second color when the auxiliary assembly 140 is being operated. In some embodiments, the auxiliary light assembly 230 includes a plurality of the auxiliary lights 232.

As shown in FIGS. 3, 7, and 9, the auxiliary light assembly 230 also includes a third camera, shown as auxiliary camera 234 (e.g., an implement camera, an operation camera, etc.). The auxiliary camera 234 is configured to provide image data corresponding to the operation of the auxiliary assembly 140. For example, the auxiliary camera 234 may capture image data corresponding to objects being handled by the auxiliary assembly 140 (e.g., a refuse container being engaged by a lift arm, a refuse container being engaged by a grabber, etc.). As another example, the auxiliary camera 234 may capture image data corresponding to objects being targeted by the auxiliary assembly 140 (e.g., a fire being targeted by a water turret, etc.). As yet another example, the auxiliary camera 234 may capture image data corresponding to the auxiliary assembly 140. In some embodiments, the auxiliary camera 234 is positioned in a predetermined location relative to the auxiliary light 232. For example, the auxiliary camera 234 may be positioned a first predetermined distance away from a first of the auxiliary lights 232 and a second predetermined distance away from a second of the auxiliary lights 232. In some embodiments, the first predetermined distance is equal to the second predetermined distance. In other embodiments, the first predetermined distance is not equal to the second predetermined distance.

As shown in FIGS. 6 and 7, the auxiliary light assembly 230 includes a third fixture (e.g., a third housing, a third mount, etc.), shown as auxiliary fixture 236. The auxiliary fixture 236 is configured to receive the auxiliary light 232 and the auxiliary camera 234 such that the auxiliary camera 234 is positioned in the predetermined location relative to the auxiliary light 232. For example, the auxiliary fixture 236 may include a first aperture configured to receive the auxiliary light 232 and a second aperture positioned in the predetermined location relative to the first aperture configured to receive the auxiliary camera 234 such that the auxiliary light 232 and the auxiliary camera 234 are disposed within the auxiliary fixture 236 when they are received by the auxiliary fixture 236. In various embodiments, the auxiliary fixture 236 is configured to receive a plurality of the auxiliary lights 232 and/or a plurality of the auxiliary cameras 234 such that the auxiliary cameras 234 are positioned in predetermined locations relative to each of the auxiliary lights 232.

As shown in FIG. 6, the vehicle 100 includes the auxiliary assembly 140 with the auxiliary light assembly 230 configured as a side-loading lift assembly and the auxiliary light assembly coupled to a portion of the side-loading lift assembly. In other embodiments, the side-loading lift assembly and the auxiliary light assembly is coupled to the body 120. In some embodiments, the auxiliary light assembly 230 is similarly positioned on the front-loading lift assembly or on the cab 130 for the vehicle 100 of FIG. 5. By way of example, the auxiliary light assembly 230 may be configured to illuminate a waste receptacle being engaged by the side-loading lift assembly and/or the front-loading lift assembly and provide image data of the waste receptacle. For example, the image data may be provided to an operator of the vehicle 100 and the illumination of the waste receptacle may improve a quality of the image data. In some embodiments, the auxiliary light assembly 230 is positioned proximate or on an aerial ladder of the vehicle 100 of FIGS. 2-4. In some embodiments, the auxiliary light assembly 230 is positioned proximate or on a concrete chute or mixing drum of the vehicle 100 of FIG. 7.

As shown in FIGS. 1, 2, 4, 8, and 9, the integrated camera and light system 200 includes at least one fourth light assembly, shown as lightbar assembly 240. The lightbar assembly 240 is configured to emit lights in various patterns, with various colors, at various frequencies, and/or with varying intensities or brightness. For example, the lightbar assembly 240 may emit pulsing lights, strobing lights, constant lights (e.g., spotlight), colored lights, etc. The lightbar assembly 240 may provide flashing lights or controlled to flash such that, when flashing, that the lightbar assembly 240 indicates that the vehicle 100 is deployed for emergency purposes (e.g., to respond to a fire, a motor vehicle accident, etc.) or actively working (e.g., along a construction site, along a refuse pickup route, etc.). In some embodiments, one or more components of the lightbar assembly 240 emit a constant, bright light to illuminate a scene so operators, emergency personnel, workers, etc. may be able to see an otherwise dark scene or the vehicle 100, for example. In some embodiments, the lightbar assembly 240 is coupled on a top surface of the cab 130 of the vehicle 100. In other embodiments, the lightbar assembly 240 is otherwise mounted or otherwise affixed to the vehicle 100 at or on other surfaces or components thereof. In some embodiments, the lightbar assembly 240 and/or the components of the lightbar assembly 240 discussed in more detail herein are modular.

As shown in FIGS. 4 and 9, the lightbar assembly 240 includes a fourth light element, shown as lightbar light 242. The lightbar light 242 is configured to emit lights in various patterns, with various colors, at various frequencies, and/or with varying intensity or brightness. In some embodiments, the lightbar assembly 240 includes a plurality of the lightbar lights 242. In various embodiments, each of the lightbar lights 242 of the lightbar assembly 240 is configured to operate independently. For example, a first of the lightbar light 242 may be configured to operate with a first frequency and a first color and a second of the lightbar light 242 may be configured to operate with a second frequency and a second color. In some embodiments, the lightbar light 242 is configured to selectively emit light in an output direction. In one embodiment, the lightbar light 242 is fixed such that the output direction is constant or fixed. In another embodiment, the lightbar light 242 is configured to rotate such that the output direction of the lightbar light 242 is constantly changing or variable.

As shown in FIGS. 4 and 9, the lightbar assembly 240 includes a fourth camera, shown as lightbar camera 244. The lightbar camera 244 is configured to provide image data corresponding to the surroundings of the vehicle 100. For example, the lightbar camera 244 may capture image data corresponding to objects positioned in front of the vehicle 100. In some embodiments, the lightbar camera 244 is positioned in a predetermined location relative to the lightbar light 242. For example, the lightbar camera 244 may be positioned a first predetermined distance away from the lightbar light 242. As another example, for the lightbar assembly 240 that includes multiple of the lightbar lights 242, the lightbar camera 244 may be positioned a first predetermined distance away from a first of the lightbar light 242 and a second predetermined distance away from a second of the lightbar light 242. In some embodiments, the first predetermined distance is equal (e.g., equidistant, etc.) to the second predetermined distance. In other embodiments, the first predetermined distance is not equal to the second predetermined distance.

As shown in FIG. 4, the lightbar assembly 240 includes a fourth fixture (e.g., a fourth housing, a fourth mount, etc.), shown as lightbar fixture 246. The lightbar fixture 246 is configured to receive the lightbar light 242 and the lightbar camera 244 such that lightbar camera 244 is positioned in a predetermined location relative to the lightbar light 242. For example, the lightbar light 242 and the lightbar camera 244 may be disposed within the lightbar fixture 246 such that the lightbar camera 244 is a predetermined distance away from the lightbar light 242. In various embodiments, the lightbar fixture 246 is configured to receive a plurality of the lightbar lights 242 and/or a plurality of the lightbar cameras 244 such that the lightbar cameras 244 are positioned in predetermined locations relative to each of the lightbar lights 242.

According to the exemplary embodiment shown in FIG. 4, the vehicle 100 includes the lightbar assembly 240 coupled to the top surface of the cab 130. The lightbar assembly 240 includes the lightbar fixture 246 coupled to the top surface of the cab 130. One of the lightbar cameras 244 and a pair of the lightbar lights 242 are disposed within the lightbar fixture 246. The pair of the lightbar lights 242 are positioned on either side of the headlight camera 214. The lightbar camera 244 is positioned in a predetermined location relative to each of the pair of the lightbar lights 242.

As shown in FIGS. 1, 2, 5, 6, 8, and 9, the integrated camera and light system 200 includes a fifth light assembly, shown as warning light assembly 250. The warning light assembly 250 is configured to emit lights in various patterns, with various colors, at various frequencies, and/or with varying intensities or brightness. The warning light assembly 250 may provide flashing lights or controlled to flash such that, when flashing, indicate that the vehicle 100 is deployed for emergency purposes (e.g., to respond to a fire, a motor vehicle accident, etc.) or actively working (e.g., along a construction site, along a refuse pickup route, etc.). In some embodiments, one or more components of the warning light assembly 250 emit a constant, bright light to illuminate a scene so operators, emergency personnel, workers, etc. may be able to see an otherwise dark scene or the vehicle 100, for example. In some embodiments, the integrated camera and light system 200 includes a plurality of the warning light assemblies 250 (e.g., a first warning assembly, a second warning assembly, a third warning assembly, etc.). In some embodiments, the warning light assembly 250 is coupled to a side surface of the body 120 of the vehicle 100. In some embodiments, the warning light assembly 250 is coupled to a top surface of the body 120 of the vehicle 100. In various embodiments, the warning light assembly 250 is otherwise mounted or otherwise affixed to the vehicle 100 at or on other surfaces or components thereof.

As shown in FIGS. 1, 5, and 6, the warning light assembly 250 includes a fifth light element, shown as warning light 252. The warning light 252 is configured to emit lights in various patterns, with various colors, at various frequencies, and/or with varying intensity or brightness. In some embodiments, the warning light assembly 250 includes a plurality of the warning lights 252. In various embodiments, each of the warning lights 252 of the warning light assembly 250 is configured to operate independently.

As shown in FIGS. 1, 5, and 6, the warning light assembly 250 includes a fifth camera, shown as warning camera 254. The warning camera 254 is configured to provide image data corresponding to the surroundings of the vehicle 100. For example, when the warning light assembly 250 is coupled to the side surface of the body 120 of the vehicle 100, the warning camera 254 may capture image data corresponding to objects positioned on a side of the vehicle 100. In some embodiments, the warning camera 254 is positioned in a predetermined location relative to the warning light 252. For example, the warning camera 254 may be positioned a predetermined distance away from the warning light 252.

As shown in FIGS. 1, 5, and 6, the warning light assembly 250 includes a fifth fixture (e.g., a fifth housing, a fifth mount, etc.), shown as warning fixture 256. The warning fixture 256 is configured to receive the warning light 252 and the warning camera 254 such that the warning camera 254 is positioned in a predetermined location relative to the warning light 252. In various embodiments, the warning fixture 256 is configured to receive a plurality of the warning lights 252 and/or a plurality of the warning camera 254 such that the warning cameras 254 are positioned in predetermined locations relative to each of the warning lights 252. For example, the warning fixture 256 may be coupled to a side of the body 120 of the vehicle 100 and the warning light 252 and the warning camera 254 may be disposed within the warning fixture 256.

As shown in FIGS. 1, 5, and 6, the vehicle 100 includes the warning light assembly 250 coupled to a side surface of the body 120 of the vehicle 100. The warning light assembly 250 may be operated to warn people of an operation of the vehicle 100. For example, the warning light assembly 250 may be configured to emit lights during the operation of the auxiliary assembly 140 (e.g., the front-loading lift arms, the side-loading lift arm, the aerial ladder, etc.). Additionally, the warning light assembly 250 may be configured to capture image data during the operation of the warning light assembly 250. The image data from the warning light assembly 250 may be used to identify a person approaching the vehicle 100 during the operation of the auxiliary assembly 140, for example.

As shown in FIG. 9, the integrated camera and light system 200 includes wiring, shown as wiring 260. The wiring 260 may be communicably coupled to the headlight assembly 210, the taillight assembly 220, the auxiliary light assembly 230, the lightbar assembly 240, and/or the warning light assembly 250, and may be configured to facilitate transmitting commands, data, or information to and acquire image data from the headlight assembly 210, the taillight assembly 220, the auxiliary light assembly 230, the lightbar assembly 240, and/or the warning light assembly 250.

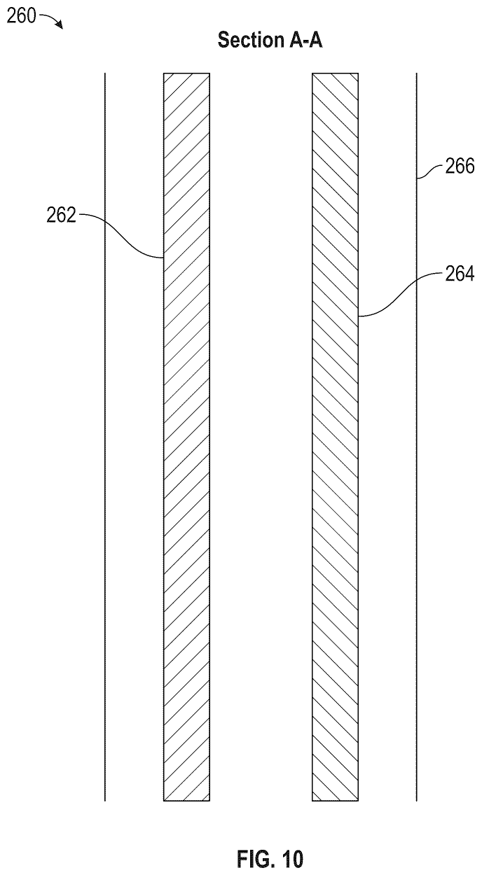

As shown in FIG. 10, the wiring 260 includes first wiring, shown as light wiring 262, communicably coupled to the lights of the integrated camera and light system 200. The light wiring 262 is configured to facilitate transmitting commands, data, or information to the lights of the integrated camera and light system 200. In some embodiments, the light wiring 262 is configured to transmit electrical power to the lights of the integrated camera and light system 200 (e.g., from a battery of the vehicle 100, etc.).

As shown in FIG. 10, the wiring 260 includes second wiring, shown as camera wiring 264, communicably coupled to the cameras of the integrated camera and light system 200. The camera wiring 264 is configured to facilitate transmitting commands, data, or information to/from the cameras of the integrated camera and light system 200. In some embodiments, the camera wiring 264 is configured to transmit electrical power to the cameras of the integrated camera and light system 200 (e.g., from a battery of the vehicle 100, etc.). In some embodiments, the light wiring 262 and the camera wiring 264 are the same wiring.

As shown in FIG. 10, the wiring 260 includes a wiring jacket, shown as wiring jacket 266, that surrounds the light wiring 262 and the camera wiring 264. The wiring jacket 266 may be configured to contain the light wiring 262 and the camera wiring 264 such that the light wiring 262 and the camera wiring 264 are held together and do not separate from each other while traversing the vehicle 100 to the components of the integrated camera and light system 200. For example, the wire jacket 266 may extend from one of the fixtures of the integrated camera and light system 200 while containing the light wiring 262 communicably coupled to at least one of the lights of the integrated camera and light system 200 disposed within the one of the fixtures and containing the camera wiring 264 communicably coupled to at least one of the cameras of the integrated camera and light system 200 disposed within the one of the fixtures. In some embodiments, the wiring 260 does not include the wiring jacket 266.

According to an exemplary embodiment, the integrated camera and light system 200 include one or more filters positioned to filter (e.g., pre-filter, etc.) out light emitted from the lights of the integrated camera and light system 200. The filter may be integrated into the cameras, or the filter may be a separate component (e.g., integrated into a lens or cover of the light fixtures). For example, the filter may be configured to reduce an intensity of a light emitted from one of the lights of the integrated camera and light system 200 before the light reaches one of the cameras of the integrated camera and light system 200. For example, the lightbar camera 244 may include a filter that is configured to reduce an intensity of the light emitted from the lightbar light 242 before the light reaches the lightbar camera 244. In some embodiments, the configuration of the filter is based on the camera of the integrated camera and light system 200 being positioned in the predetermined location relative to the light of the integrated camera and light system 200. For example, the filter included in the lightbar camera 244 may be positioned in a direction toward the lightbar light 242 to maximize the amount of the light emitted by the lightbar light 242 that passes through the filter before reaching the lightbar camera 244. In various embodiments, the filter may be configured based on a color of the light emitted by the lights of the integrated camera and light system 200, an intensity of the light emitted by the lights of the integrated camera and light system 200, a polarization of the light emitted by the lights of the integrated camera and light system 200, etc.

### Control System

Referring to FIGS. 1, 2, and 5-8, the vehicle 100 may include a control system, shown as controller 400, according to some embodiments. As shown in FIG. 9, the controller 400 includes a processing circuit 402. The processing circuit 402 includes one or more processors 404 and a memory 406 (e.g., one or more processing circuits, etc.). The processor 404 may be a general or specific purpose processor, an application specific integrated circuit (ASIC), one or more field programmable gate arrays (FPGAs), a group of processing components, or other suitable processing components. According to an exemplary embodiment, the one or more processors 404 may be coupled to the memory 406 and may be configured to execute computer code or instructions stored in the memory 406 or acquired from other computer-readable media (e.g., USB drive, network storage, remote server, etc.). The memory 406 may include one or more memory devices (e.g., memory units, storage devices, etc.) for storing data and/or computer code for completing and/or facilitating the various processes described herein. The memory may include random access memory (RAM), read-only memory (ROM), hard drive storage, temporary storage, non-volatile memory, flash memory, optical memory, or any other suitable memory for storing software objects and/or computer instructions. The memory 406 may include database components, object code components, script components, or any other type of information structure for supporting the various activities described herein in connection with the systems, apparatuses, and methods for communicating with and/or controlling the integrated camera and light system 200. The memory 406 may be communicably coupled to the processor 404 and may include computer code that, when executed by the one or more processors, performs one or more of the processes described herein.

The controller 400 may be configured to transmit commands, data, or information to the integrated camera and light system 200, as described herein. Likewise, the controller 400 may be configured to acquire commands, data, or information from the integrated camera and light system 200. In some embodiments, the commands, data, or information transmitted from or acquired by the controller 400 is related to control, configuration, settings, troubleshooting, diagnostics, etc. of the integrated camera and light system 200. For example, the controller 400 may acquire image data from the cameras of the integrated camera and light system 200. In some embodiments, one or more of the components of the integrated camera and light system 200 include microprocessors communicably coupled with the controller 400 and configured to acquire the commands, data, or information from the controller 400 and operate the components of the integrated camera and light system 200 according to the commands, data, or information. In some embodiments, the controller 400 is integrated or at least partially integrated into the integrated camera and light system 200. For example, a first processor may be part of the integrated camera and light system 200 (e.g., to perform light filtering, a light processor, etc.) and a second processor may be part of the vehicle 100 (e.g., a vehicle processor, to control the other components of the vehicle 100 based on the camera data, etc.)

The controller 400 may be communicably coupled to one or more other vehicle systems, such as hydraulic systems, electrical systems, electromechanical systems, or otherwise. For example, the controller 400 may be communicably coupled to a prime mover (e.g., an engine, a motor, etc.), a pumping system, a ladder system, an outrigger system, a lift system, a mixer system, and/or another system of the vehicle 100. In various embodiments, the controller 400 may be configured to transmit commands, data, or information to the various systems of the vehicle 100 in order to control (i.e., permit, prevent, modify) various functions of the vehicle 100.

As shown in FIG. 9, the controller 400 includes a communication interface 408. The communication interface 408 may be configured to facilitate wired or wireless communication between (i) the controller 400 and (ii) the integrated camera and light system 200 and/or other components/systems of the vehicle 100. The communication interface 408 may include programming and/or hardware-based components that connect the controller 400 of the vehicle 100 to the integrated camera and light system 200 over a wired or wireless network. For example, the communication interface 408 may include a wireless transceiver (e.g., Bluetooth® transceiver, cellular modem, a Wi-Fi® transceiver) and/or a wired connection. In some embodiments, the communication interface 408 includes hardware and machine-readable media structured to support communication over multiple channels of data communication (e.g., wireless, Bluetooth®, near-field communication, etc.). The communication interface 408 may include one or more cryptography modules to establish a secure communication session (e.g., using the IPSec protocol or similar) in which data communicated over the session is encrypted and securely transmitted. As shown in FIG. 9, the communication interface 408 is communicably coupled to the wiring 260 and connects the controller 400 to the integrated camera and light system 200 through the wiring 260. In other embodiments, the controller 400 and the communication interface 408 are separated into separate components or devices.

In some embodiments, the controller 400 is configured to process the image data provided by the integrated camera and light system 200 to generate processed image data. The controller 400 may process the image data provided by the integrated camera and light system 200 to reduce interference in the image data. In some embodiments, the controller 400 is configured to process the image data provided by the integrated camera and light system 200 to reduce interference caused by light emitted from the lights of the integrated camera and light system 200. For example, the controller 400 may acquire image data provided by the headlight camera 214 of the headlight assembly 210 and process the image data to reduce the interference caused by light emitted from the headlight 212. In some embodiments, the controller 400 is configured to process image data provided by the integrated camera and light system 200 to reduce interference caused by light in the image data caused by each of the components of the integrated camera and light system 200. For example, the controller 400 may acquire image data provided by the auxiliary camera 234 of the auxiliary light assembly 230 and process the image data to reduce the interference caused by light emitted from the auxiliary light 232 and caused by light emitted from the lightbar light 242 of the lightbar assembly 240.

In some embodiments, the controller 400 may utilize the predetermined location of one of the cameras of the integrated camera and light system 200 relative to the lights of the integrated camera and light system 200 to reduce the interference in the image data provided by the one of the cameras. For example, the controller may utilize a position of the one of the cameras of the integrated camera and light system 200 relative to the lights of the integrated camera and light system 200 to identify and reduce the interference in the image data provided by the one of the cameras. For example, the controller 400 may utilize a distance between the lightbar camera 244 and the lightbar light 242 of the lightbar assembly 240 to identify interference caused by the lightbar light 242 in the image data provided by the lightbar camera 244. The controller 400 may utilize the distance to determine a quantity or a quality of light from the lightbar light 242 that reaches the lightbar camera 244. The controller 400 may then reduce the interference in the image data based on the quantity of light from the lightbar light 242 that reaches the lightbar camera 244.

In some embodiments, the controller 400 may further utilize characteristics of the lights of the integrated camera and light system 200 to reduce the interference caused by the lights of the integrated camera and light system 200 in the image data provided by the one of the cameras of the integrated camera and light system 200. For example, the controller 400 may utilize a frequency of the light emitted from the lightbar light 242 of the lightbar assembly 240 to reduce the interference caused by the lightbar light 242 in the image data provided by the lightbar camera 244. As an example, the controller 400 may utilize temporal filtering (e.g., time based filtering, etc.) to reduce the interference caused by the lightbar light 242 in the image data provided by the lightbar camera 244 by applying a filter that corresponds to the light emitted by the lightbar light 242 when the lightbar light 242 is emitting light and not applying the filter when the lightbar light 242 is not emitting light. As another example, the controller 400 may utilize an output direction of the light emitted from the lightbar light 242 of the lightbar assembly 240 to reduce the interference caused by the lightbar light 242 in the image data provided by the lightbar camera 244. The controller 400 may apply a filter corresponding to the lightbar light 242 on the image data provided by the lightbar camera 244 when the output direction of the light emitted from the lightbar light 242 is aimed at the lightbar camera 244. In some embodiments, the controller 400 may utilize a color of the lights of the integrated camera and light system 200 to reduce the interferences caused by the lights of the integrated camera and light system 200 in the imaged data provided by one of the cameras of the integrated camera and light system 200. For example, if the lightbar light 242 emits a red light and a blue light, the controller 400 may apply a filter corresponding to the red light and the blue light on the image data provided by the lightbar camera 244 to reduce the interference caused by the lightbar light 242.

In some embodiments, the controller 400 is configured to utilize the processed image data to operate the vehicle 100. For example, the controller 400 may operate the auxiliary assembly 140 of the vehicle 100 based on the processed image data that was originally the image data provided from the cameras. As another example, the controller 400 may operate the vehicle 100 to drive autonomously based on the processed image data.

As shown in FIG. 9, the vehicle 100 includes at least one user interface (e.g., a display), shown as display 450. The display 450 may be and/or include a screen, a monitor, a visual display device, a television, a video display, a liquid crystal display (LCD), a light emitting diode (LED) display, an infotainment system, a mobile device, and/or among other possible displays and/or devices. For example, the display 450 may be an infotainment system disposed within the cab interior 132 of the cab 130 of the vehicle 100. In some embodiments, the display 450 is a touchscreen display that receives a touch input from a user. The display 450 may support any type of display feature, such as a flipbook-style animation, or any other type of transition feature. The display 450 may generally provide a plurality of navigation buttons that allow a user to select various displays and other options via touch.

The display 450 may generate, produce, provide and/or otherwise display a user interface. For example, the display 450 may display a user interface that includes video feeds corresponding to the image data provided by the cameras of the integrated camera and light system 200. For example, the display 450 may display a user interface that includes video feeds corresponding to the image data provided by the lightbar camera 244 of the lightbar assembly 240. In some embodiments, the display 450 may display the processed image data from the controller 400. For example, the display 450 may display the image data from the cameras of the integrated camera and light system 200 that have been processed by the controller 400 to reduce the interference caused by the lights of the integrated camera and light system 200. The display 450 may also display a user interface that includes graphical representations of a location proximate the vehicle 100 or proximate to an incident or scene. For example, the display 450 may display a user interface that includes a graphical representation of the surroundings of the vehicle 100. The display 450 may also display a user interface and an operator of the display 450 may input data (e.g., commands, selections, etc.) via the user interface. The display 450 may provide the data inputted, via the user interface, to the integrated camera and light system 200. For example, the display 450 may receive, via a user interface, an activation of the integrated camera and light system 200 and the display 450 may provide the activation to the integrated camera and light system 200 via the controller 400. In other embodiments, the vehicle 100 includes other types of user interface devices, such as buttons, knobs, switches, sliders, microphones, or other input devices.

According to an exemplary embodiment, the arrangement of the cameras of the integrated camera and light system 200 in predetermined locations relative to the lights of the integrated camera and light system 200 of the present disclosure provides various advantages relative to prior vehicle integrated camera systems. Traditionally, vehicle camera systems and vehicle light systems are (i) separately mounted to the vehicle and (ii) mounted in different configurations across different vehicles such that the cameras may be located in different positions relative to the lights in different vehicles. The integrated camera and light system 200 disclosed herein facilitates integrating the light system of the vehicle 100 with the camera system of the vehicle 100, and, therefore, permits the cameras of the integrated camera and light system 200 to be positioned at predetermined locations relative to the lights of the integrated camera and light system 200. The controller 400 can then process image data provided by the cameras of the integrated camera and light system 200 to reduce interference caused by the lights of the integrated camera and light system 200 based on the cameras being positioned at the predetermined locations relative to the lights. Additionally, the controllers 400 of multiple of the vehicles 100 may process the image data provided by the cameras of the integrated camera and light system 200 of each of the vehicles 100 utilizing the same processing operations based on the cameras of each of the vehicles being positioned at the predetermined locations relative to the lights of the integrated camera and light system 200 of each of the vehicles 100. Further, by combining the wiring of the camera system and the light system into the wiring 260, the wiring complexity of the vehicle 100 may be reduced, which can reduce time spent on manufacturing, installation, and repairs. In addition, the modular nature of the components of the integrated camera and light system 200 facilitates ease of replacement of the components and reduces down time of the vehicles 100, since broken components of the integrated camera and light system 200 can be replaced and repaired offline while the vehicle 100 continues to operate.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 100 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle comprising:
a chassis;
a cab coupled to the chassis;
a body coupled to the chassis;
an integrated camera and light system including:
a fixture;
a light element disposed within the fixture, the light element configured to emit a light; and
a camera disposed within the fixture and positioned at a predetermined location relative to the light element, the camera configured to acquire image data, wherein the image data includes interference corresponding to the light emitted by the light element; and
one or more processing circuits configured to:
acquire the image data; and
process the image data to reduce or filter the interference in the image data based on the camera being positioned at the predetermined location relative to the light element.

2. The vehicle of claim 1, wherein:
the light element is configured to emit the light with one or more characteristics; and
the one or more processing circuits are configured to process the image data to reduce or filter the interference in the image data based on the one or more characteristics.

3. The vehicle of claim 1, wherein the integrated camera and light system includes a filter positioned between the light element and the camera, the filter configured to pre-filter the light emitted by the light element.

4. The vehicle of claim 1, wherein the fixture defines:
a first aperture configured to receive the light element; and
a second aperture configured to receive the camera such that the camera is positioned at the predetermined location relative to the light element.

5. The vehicle of claim 1, further comprising:
a first wire communicably coupling the light element to the one or more processing circuits;
a second wire communicably coupling the camera to the one or more processing circuits; and
a wiring jacket surrounding at least a portion of the first wire and the second wire.

6. The vehicle of claim 5, wherein the wiring jacket surrounds the portion of the first wire and the second wire extending out of the fixture.

7. The vehicle of claim 1, further comprising a display, wherein the one or more processing circuits are configured to generate and provide, to the display, a display interface corresponding to the processed image data.

8. The vehicle of claim 1, wherein:
the fixture is a lightbar fixture coupled to the cab;
the light element is a lightbar light configured to emit the light with at least one of various patterns, various colors, various frequencies, or various brightnesses; and
the one or more processing circuits are configured to process the image data to reduce or filter the interference in the image data based on the at least one of the various patterns, the various colors, the various frequencies, or the various brightnesses.

9. The vehicle of claim 1, further comprising:
an auxiliary assembly coupled to at least one of the chassis, the body, or the cab, the auxiliary assembly including an implement that facilities a function of the vehicle;
wherein the fixture is an auxiliary fixture coupled to the auxiliary assembly; and
wherein the one or more processing circuits are configured to operate the implement to perform the function based on the processed image data.

10. The vehicle of claim 1, wherein the fixture is at least one of a headlight fixture coupled to a forward end of the cab or a taillight fixture coupled to a rearward end of the body.

11. The vehicle of claim 1, wherein:
the integrated camera and light system includes an additional light element configured to emit an additional light, the additional light element disposed either within the fixture or outside of the fixture;
the camera is positioned at an additional predetermined location relative to the light element;
the image data includes additional interference corresponding to the additional light emitted by the additional light element; and
the one or more processing circuits are configured to process the image data to reduce or filter the additional interference in the image data based on the camera being positioned at the additional predetermined location relative to the additional light element.

12. A vehicle comprising:
a chassis;
a body assembly coupled to the chassis;
an integrated camera and light system including:
a first light element configured to emit a first light;
a second light element configured to emit a second light; and
a camera positioned at a first predetermined location relative to the first light element and at a second predetermined location relative to the second light element, the camera configured to acquire image data, wherein the image data includes first interference corresponding to the first light emitted by the first light element and second interference corresponding to the second light emitted by the second light element; and
one or more processing circuits configured to:
acquire the image data;
process the image data to reduce or filter the first interference in the image data based on the camera being positioned at the first predetermined location relative to the first light element; and
process the image data to reduce or filter the second interference in the image data based on the camera being positioned at the second predetermined location relative to the second light element.

13. The vehicle of claim 12, wherein:
the integrated camera and light system includes a fixture coupled to the body assembly; and
the first light element, the second light element, and the camera are disposed within the fixture.

14. The vehicle of claim 13, wherein the camera is equidistant from the first light element and the second light element.

15. The vehicle of claim 13, wherein the camera is positioned between the first light element and the second light element.

16. The vehicle of claim 13, wherein the body assembly include a cab, and wherein the fixture is a lightbar coupled to the cab.

17. The vehicle of claim 12, wherein the integrated camera and light system includes at least one filter positioned between the first light element and the camera and between the second light element and the camera, the at least one filter configured to pre-filter the first light emitted by the first light element and the second light emitted by the second light element.

18. The vehicle of claim 12, further comprising a display, wherein the one or more processing circuits are configured to generate and provide, to the display, a display interface corresponding to the processed image data.

19. The vehicle of claim 12, wherein:
the integrated camera and light system includes a fixture;
the first light element and the camera are disposed within the fixture; and
the second light element is disposed outside of the fixture.

20. An integrated camera and light system for a vehicle, the integrated camera and light system comprising:
a fixture;
a light element disposed within the fixture, the light element configured to emit a light;
a camera disposed within the fixture and positioned at a predetermined location relative to the light element, the camera configured to acquire image data;
a filter positioned between the light element and the camera, the filter configured to filter the light emitted by the light element;
a first wire communicably coupled to the light element, the first wire extending out of the fixture;
a second wire communicably coupled to the camera, the second wire extending out of the fixture; and
a wiring jacket surrounding at least a portion of the first wire and the second wire extending out of the fixture.
